(19) United States
(12) Patent Application Publication
(10) Pub. No.: US 2010/0081474 A1
(43) Pub. Date: Apr. 1, 2010

(54) WIRELESS BASE STATION, A REFERENCE TERMINAL APPARATUS AND A WIRELESS COMMUNICATION SYSTEM

(75) Inventor: Seijiro YONEYAMA, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/564,649

(22) Filed: Sep. 22, 2009

(30) Foreign Application Priority Data
Sep. 30, 2008 (JP) 2008-255613

(51) Int. Cl. H04B 1/38

(52) U.S. Cl. 455/561

(57) ABSTRACT

In a wireless base station, a storage unit stores an identifier of a reference terminal apparatus to control a wireless connectable area of the wireless base station. A decision unit decides whether an identifier received from the outside coincides with the identifier stored in the storage unit. A control unit controls a transmit power so that a radio propagation quality between the wireless base station and the reference terminal apparatus represents the wireless connectable area, when the identifier received from the outside coincides with the identifier stored in the storage unit.

### CROSS-REFERENCE TO RELATED APPLICATIONS

This application is based upon and claims the benefit of priority from Japanese Patent Application No. 2008-255613, filed on Sep. 30, 2008; the entire contents of which are incorporated herein by reference.

### FIELD OF THE INVENTION

The present invention relates to a wireless base station, a reference terminal apparatus and a wireless communication system for controlling a wireless connectable area of the wireless base station.

### BACKGROUND OF THE INVENTION

In a wireless LAN system of IEEE802.11 standard that adopts the CSMA/CA access method, by controlling a transmit power of a wireless base station, a size of a wireless connectable area (a cell) of the wireless base station is adjusted. A receive power of the wireless base station is represented as following equation. As shown in this equation, fall of the receive power by space loss can be covered by the transmit power.

Pᵣₛ=Pₜ+α−(τ−β)

Pᵣₛ: receive power (dBm)

Pₜ: transmit power (dBm)

α: gain of transmit-receive antenna (dB)

τ: space loss (dB)

β: loss of transmit-receive feeding system

With regard to the IEEE802.11 standard, based on a distance or a radio propagation quality between the wireless base station and a wireless terminal, a function (called “TPC (Transmit Power Control)”) to automatically control a transmit power of the wireless base station is prescribed. This function is disclosed in IEEE Std. 802.11-2007 Section 11.8, “Wireless LAN Medium Access Control (MAC) and Physical Layer (PHY) Specifications”.

In this function, by setting the minimum transmit power necessary for the distance, the transmit power can be saved. Furthermore, when a radio propagation quality falls, by increasing or decreasing the transmit power, the radio propagation quality can be recovered.

With regard to the IEEE802.11 standard, if a plurality of wireless terminals exist, a transmit power is automatically controlled to be suitable for each terminal. Accordingly, a user of the wireless terminal cannot understand how the wireless connectable area is formed and at which physical location the terminal can stably communicate.

Furthermore, the user of the wireless terminal must repeatedly operate adjustment to set the transmit power of the wireless base station, while the user is taking a communication status of the wireless terminal into consideration.

Furthermore, a movable shelter appears on the radio propagation path between the wireless base station and the wireless terminal, the space loss and the radio propagation quality change. Accordingly, it is difficult for the user to operate the adjustment that a predetermined space (terminal communication space) is always covered with the wireless connectable area.

### SUMMARY OF THE INVENTION

The present invention is directed to a wireless base station, a reference terminal apparatus and a wireless communication system for a user of a terminal apparatus to easily understand a physical location connectable with the wireless base station.

According to an aspect of the present invention, there is provided a wireless base station comprising: a storage unit configured to store an identifier of a reference terminal apparatus to control a wireless connectable area of the wireless base station; a decision unit configured to decide whether an identifier received from the outside coincides with the identifier stored in the storage unit; and a control unit configured to control a transmit power so that a radio propagation quality between the wireless base station and the reference terminal apparatus represents the wireless connectable area, when the identifier received from the outside coincides with the identifier stored in the storage unit.

According to another aspect of the present invention, there is also provided a reference terminal apparatus to control a wireless connectable area of a wireless base station, comprising: a storage unit configured to store an identifier of the reference terminal apparatus, the identifier being stored in the wireless base station; and an interface unit configured to wirelessly transmit the identifier to the wireless base station.

According to still another aspect of the present invention, there is also provided a wireless communication system comprising: a wireless base station which stores an identifier of a reference terminal apparatus to control a wireless connectable area of the wireless base station; and the reference terminal apparatus which stores the identifier; wherein the reference terminal apparatus wirelessly transmits the identifier to the wireless base station, and wherein the wireless base station control a transmit power so that a radio propagation quality between the wireless base station and the reference terminal apparatus represents the wireless connectable area, when the identifier received from the reference terminal apparatus coincides with the identifier stored in the wireless base station.

### BRIEF DESCRIPTION OF THE DRAWINGS

FIG. 1 is a block diagram of a wireless LAN system according to a first embodiment.

FIG. 2 is a block diagram of a wireless base station according to the first embodiment.

FIGS. 3A and 3B are schematic diagrams of the wireless LAN system before and after controlling a wireless connectable area according to the first embodiment.

FIG. 4 is a flow chart of the wireless base station to set an initial quality of the wireless LAN system according to the first embodiment.

FIG. 5 is a flow chart of the wireless base station to control the wireless connectable area of the wireless LAN system according to the first embodiment.

FIGS. 6A and 6B are schematic diagrams of the wireless LAN system before and after controlling the wireless connectable area according to a second embodiment.

FIG. 7 is a flow chart of the wireless base station to set the initial quality of the wireless LAN system according to the second embodiment.

FIG. 8 is a flow chart of the wireless base station to control the wireless connectable area of the wireless LAN system according to the second embodiment.

FIG. 9 is a block diagram of the wireless base station according to the second embodiment.

FIGS. 10A and 10B are schematic diagrams of the wireless LAN system before and after controlling the wireless connectable area according to a third embodiment.

FIG. 11 is one example of contents of a reference terminal identifier storage unit according to the third embodiment.

FIG. 12 is a flow chart of the wireless base station to control the wireless connectable area of the wireless LAN system according to the third embodiment.

### DETAILED DESCRIPTION OF THE EMBODIMENTS

Hereinafter, embodiments of the present invention will be explained by referring to the drawings. The present invention is not limited to the following embodiments.

### The First Embodiment

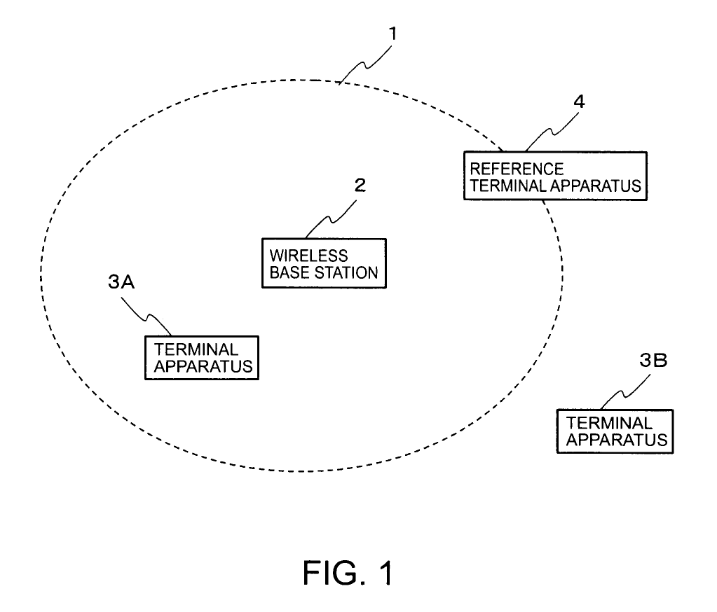

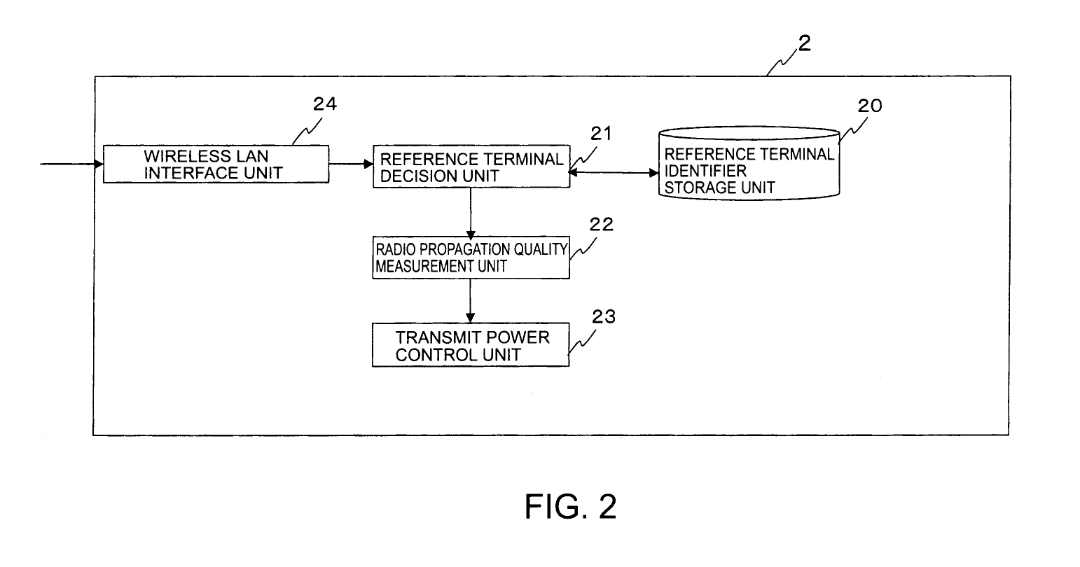

FIG. 1 is a block diagram of a wireless LAN system according to the first embodiment. FIG. 2 is a block diagram of a wireless base station. In the first embodiment, for example, the wireless LAN system is based on the IEEE802.11 standard that adopts the CSMA/CA access method.

As shown in FIG. 1, the wireless LAN system includes one wireless base station 2 having a wireless connectable area (a cell), two terminal apparatuses 3A and 3B, and one reference terminal apparatus 4. In the wireless LAN system based on the IEEE802.11 standard, the wireless base station 2, the terminal apparatuses 3A and 3B, and reference terminal apparatus 4 wirelessly communicate according to the IEEE802.11 standard.

The terminal apparatuses 3A and 3B respectively have a wireless LAN interface unit, and communicate with the wireless base station 2 via the wireless LAN interface unit. Furthermore, the terminal apparatuses 3A and 3B respectively have an identifier different from another terminal apparatus. The identifier specifies respective terminal apparatus.

The reference terminal apparatus 4 is used as a reference to set the wireless connectable area of the wireless base station 2, and is a relocatable terminal. A reference terminal identifier to specify the reference terminal apparatus (different from identifiers of another reference terminal apparatus and another terminal apparatus) is assigned to the reference terminal apparatus 4. As explained afterwards, the reference terminal identifier is previously stored in the wireless base station 2. As the reference terminal identifier, for example, a MAC address or an IP address is used. The reference terminal apparatus 4 has a wireless LAN interface unit, and communicates with the wireless base station 2 via the wireless LAN interface unit. For example, the reference terminal apparatus 4 is based on the IEEE802.11 standard.

The reference terminal apparatus 4 is desirably a movable terminal with a user in case of necessity. Furthermore, in comparison with the terminal apparatuses 3A and 3B, the reference terminal apparatus 4 is desirably a terminal for the user to easily recognize. For example, in comparison with the terminal apparatuses 3A and 3B, the reference terminal apparatus 4 has an appearance (a shape or a size) visually confirmable for the user. The appearance visually confirmable represents the shape or the size that the user can visually recognize the reference terminal apparatus 4 by distinguishing from the terminal apparatuses 3A and 3B. Briefly, by visually recognizing the reference terminal apparatus 4 different from another terminal apparatus, the user can easily understand a physical location to stably communicate with another terminal in the wireless connectable area of the wireless base station 2.

As shown in FIG. 2, the wireless base station 2 prepares a reference terminal identifier storage unit 20, a reference terminal decision unit 21, a radio propagation quality measurement unit 22, a transmit power control unit 23, and a wireless LAN interface unit 24. These units 20-24 may be composed as a hardware or a software module executed on the wireless base station 2.

Next, the wireless base station 2 is explained in detail by referring to FIG. 2. The wireless base station 2 communicates with the terminal apparatuses 3A and 3B, and the reference terminal apparatus 4 via the wireless LAN interface unit 24.

The reference terminal identifier storage unit 20 stores an identifier (reference terminal identifier) of the reference terminal apparatus 4 which is a reference to control a transmit power of the wireless base station 2. On the other hand, the reference terminal identifier storage unit 20 does not store identifiers of the terminal apparatuses 3A and 3B which are not used for controlling the transmit power.

The reference terminal decision unit 21 decides whether an identifier received by the wireless LAN interface unit 24 from the outside coincides a reference terminal identifier stored in the reference terminal identifier storage unit 20.

When the reference terminal decision unit 21 decides that the identifier received from the outside coincides with the reference terminal identifier, the radio propagation quality measurement unit 22 measures a radio propagation quality between the wireless base station 2 and the reference terminal apparatus 4. As an index representing the radio propagation quality, for example, RSSI (Received Signal Strength Indicator), BER (Bit Error Rate), and FER (Frame Error Rate), are selectively used. When the reference terminal decision unit 21 decides that the identifier received from the outside does not coincide with the reference terminal identifier, the radio propagation quality measurement unit 22 does not measure the radio propagation quality.

Based on the radio propagation quality (measured by the radio propagation quality measurement unit 22), for example, RSSI, the transmit power control unit 23 controls a transmit power so that the radio propagation quality between the wireless base station 2 and the reference terminal apparatus 4 is a predetermined quality as a wireless connectable area. As a control method of the transmit power control unit 23, the transmit power is controlled using a plurality of predetermined algorithms. For example, following three methods are used.

(1) The transmit power is controlled so that RSSI of the reference terminal apparatus having the maximum RSSI is equal to a predetermined value.

(2) The transmit power is controlled so that RSSI of the reference terminal apparatus having the minimum RSSI is equal to a predetermined value.

(3) The transmit power is controlled so that BER and FER of all reference terminal apparatuses are equal to 0%.

In the method (1), among reference terminal apparatuses, the transmit power control unit 23 controls the transmit power so that a radio propagation quality between the wireless base station 2 and a reference terminal apparatus having the highest radio propagation quality (with the wireless base station 2) is a predetermined quality as a wireless connectable area. In the method (2), among reference terminal apparatuses, the transmit power control unit 23 controls the transmit power so that a radio propagation quality between the wireless base station 2 and a reference terminal apparatus having the lowest radio propagation quality (with the wireless base station 2) is a predetermined quality as a wireless connectable area. In any of methods (1)-(2), by using the transmit power controlled, the wireless base station 2 communicates with all terminal apparatuses located in the wireless connectable area.

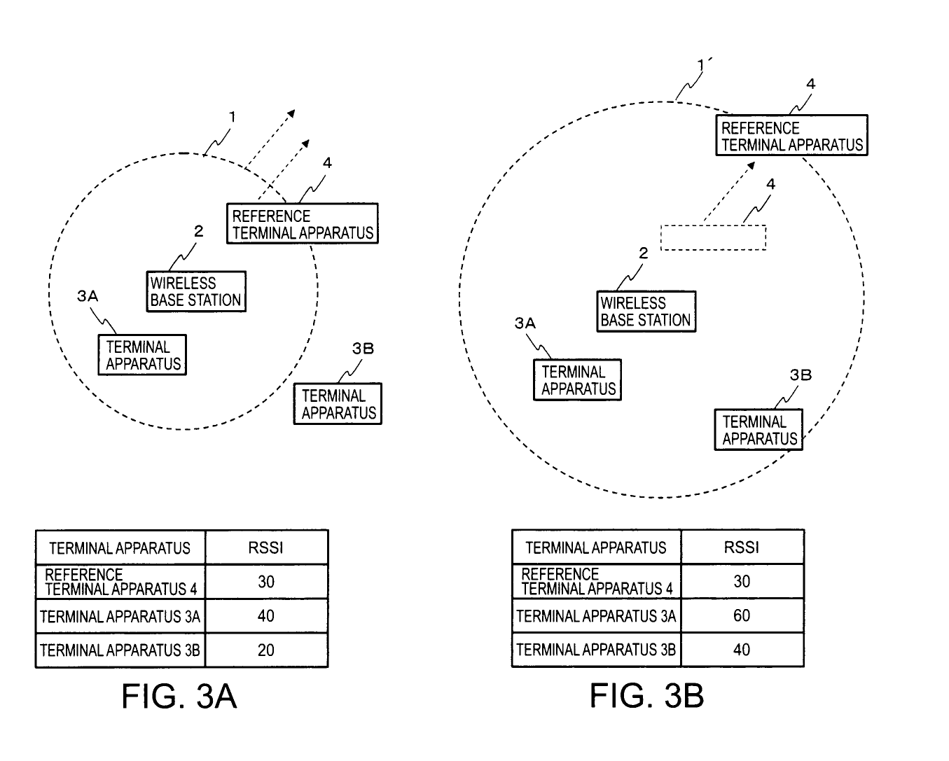

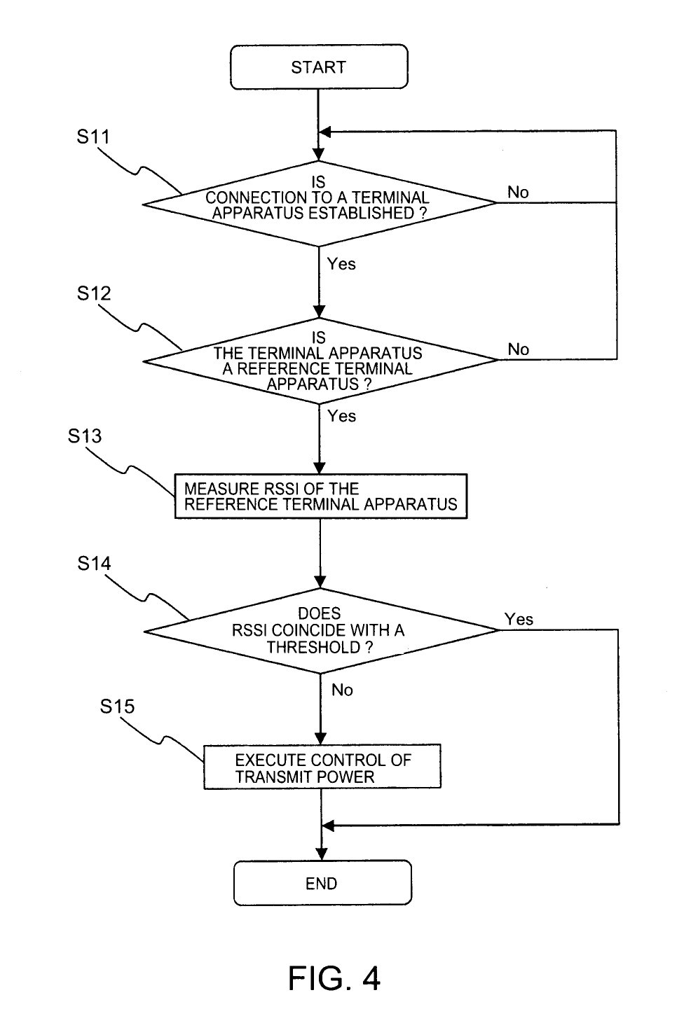

Next, a method for changing the wireless connectable area of the wireless base station 2 is explained. FIGS. 3A and 3B are block diagrams of the wireless LAN system before and after the wireless connectable area of the base station 2 is controlled. FIG. 3A is a block diagram showing an initial quality of the wireless LAN system before the wireless connectable area is controlled. FIG. 3B is a block diagram showing a quality of the wireless LAN system after the wireless connectable area is controlled. FIG. 4 is a flow chart of processing of the wireless base station 2 to set the initial quality in the wireless LAN system.

As shown in FIG. 3A, the initial quality of the wireless connectable area 1 is set based on a physical location of the reference terminal apparatus 4. The wireless connectable area is under the radio propagation quality that a modulation signal received by the terminal apparatus can be demodulated. In the first embodiment, the radio propagation quality represents that RSSI is “30”.

At the initial quality of the wireless connectable area 1, RSSI of the reference terminal apparatus 4, and RSSI of the terminal apparatuses 3A and 3B, are “30”, “40” and “20” respectively. Briefly, at the initial quality, the terminal apparatus 3A is located inside the wireless connectable area 1 of the base station 2. Accordingly, the radio propagation quality of the terminal apparatus 3A is excellent. On the other hand, the terminal apparatus 3B is located outside the wireless connectable area 1 of the base station 2. Accordingly, the radio propagation quality of the terminal apparatus 3A is poor, and fall of communication ability or interruption of communication often occurs.

Next, a method for setting the wireless connectable area based on a physical location of the reference terminal apparatus 4 is explained. In the wireless base station 2, the reference terminal identifier storage unit 20 stores a reference terminal identifier of the reference terminal apparatus 4 which is an object to control the transmit power.

First, the wireless base station 2 wirelessly connects with the terminal apparatus 3A and the reference terminal apparatus 4 in the wires connectable area, and establishes a wireless connection to respective terminal apparatus (S11). As to the wireless connection, the wireless base station 2 transmits a beacon signal, and the terminal apparatus 3A and the reference terminal apparatus 4 (located in the wireless connectable area 1) receive the beacon signal respectively. The terminal apparatus 3A and the reference terminal apparatus 4 transmit a wireless signal to the wireless base station 2 respectively. In this case, the terminal apparatus 3A transmits a wireless signal including an identifier (of the terminal apparatus 3A), and the reference terminal apparatus 4 transmits a wireless signal including a reference terminal identifier (of the reference terminal apparatus 4). On the other hand, the terminal apparatus 3B is not located in the wireless connectable area 1. Accordingly, the wireless base station 2 cannot establish a wireless connection to the terminal apparatus 3B.

Next, the reference terminal decision unit 21 decides whether identifiers received from the outside (the identifier received from the terminal apparatus 3A and the reference terminal identifier received from the reference terminal apparatus 4) coincide with the reference terminal identifiers stored in the reference terminal identifier storage unit 20 (S12). As a result, the reference terminal decision unit 21 decides that the reference terminal identifier received from the reference terminal apparatus 4 coincides with the reference terminal identifier stored in the reference terminal identifier storage unit 20, and that the identifier received from the terminal apparatus 3A does not coincide with the reference terminal identifier stored in the reference terminal identifier storage unit 20. Accordingly, the reference terminal apparatus 4 is decided as a reference to control the wireless connectable area 1.

Next, the radio propagation quality measurement unit 22 measures RSSI as a radio propagation quality between the wireless base station 2 and the reference terminal apparatus 4 (S13). Concretely, by transmitting and receiving an experimental Packet between the wireless base station 2 and the reference terminal apparatus 4, the radio propagation quality measurement unit 22 measures RSSI. As the experimental packet, for example, a NULL control frame and an ACK control frame in a MAC layer prescribed by IEEE802.11, or an ICMP (Internet Control Message Protocol), are used. Transmission and reception of the experimental packet are desirably executed a plurality of times. By executing the plurality of times, measurement accuracy of the radio propagation quality rises. Furthermore, by acquiring statistic information of RSSI on a radio propagation link between the wireless base station 2 and the reference terminal apparatus 4, RSSI may be measured.

Next, based on RSSI measured by the radio propagation measurement unit 22, the transmit power control unit 23 controls a transmit power by the algorithm (1). Briefly, the transmit power is controlled so that RSSI of the reference terminal apparatus having the maximum RSSI is equal to a predetermined value. As to the algorithm (1), a predetermined value of RSSI is “30”, and the reference terminal apparatus 4 is one unit. Accordingly, the transmit power is controlled so that RSSI of the reference terminal apparatus 4 is equal to “30”. When RSSI as a measurement result of the radio propagation quality measurement unit 22 is smaller than “30” or larger than “30”, the transmit power control unit 23 decides that the measurement result does not satisfy a threshold. On the other hand, when RSSI is equal to “30”, the transmit power control unit 23 decides that the measurement result satisfies a threshold (S14).

When the transmit power control unit 23 decides that the measurement result does not satisfy a threshold, in case of RSSI smaller than “30”, the transmit power control unit 23 increases the transmit power. In case of RSSI larger than “30”, the transmit power control unit 23 decreases the transmit power (S15).

By this operation, RSSI between the wireless base station 2 and the reference terminal apparatus 4 changes from the initial quality of FIG. 3A to “30”, and the wireless base station 2 forms the radio propagation quality to follow the wireless connectable area at a physical location of the reference terminal apparatus 4. Briefly, an area having a worse radio propagation quality than the reference terminal apparatus 4 is outside the wireless connectable area, and an area having a better radio propagation quality than the reference terminal apparatus 4 is inside the wireless connectable area.

As mentioned-above, the wireless connectable area of the base station 2 is set based on a physical location of the reference terminal apparatus 4. Accordingly, by watching the reference terminal apparatus 4, a user of a terminal apparatus can understand a location where the terminal apparatus is stably communicatable with the wireless connectable area. As a result, the user can use the terminal apparatus in the wireless connectable area, and the terminal apparatus can stably communicate with the wireless base station 2.

Furthermore, in a wireless LAN system of the first embodiment, the reference terminal apparatus 4 is set as an object to control a transmit power of the wireless base station 2. Another terminal apparatus is not set as the object. Accordingly, a wireless connectable area of the base station 2 is set based on the reference terminal apparatus 4, and the wireless connectable area can be prescribed as a predetermined area.

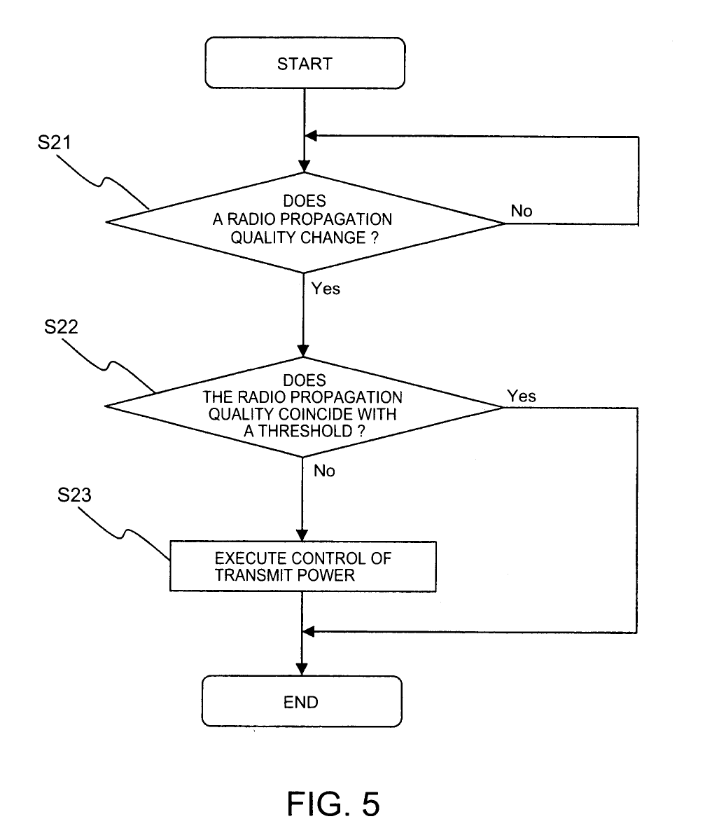

Next, in the wireless LAN system of the first embodiment, a method for changing the wireless connectable area of the base station 2 by moving the reference terminal apparatus 4 is explained. FIG. 3B is a block diagram of the wireless LAN system after the wireless connectable area of the base station 2 is changed by moving the reference terminal apparatus 4. FIG. 5 is a flow chart of processing of the wireless base station 2 to change the wireless connectable area in the wireless LAN system.

First, as shown in b FIG. 3B, a user moves the reference terminal apparatus 4 along a distant direction from the wireless base station 2. In this case, by monitoring a radio propagation quality (RSSI) between the wireless base station 2 and the reference terminal apparatus 4, the radio propagation quality measurement unit 22 detects change of RSSI (S21). When a distance between the wireless base station 2 and the reference terminal apparatus 4 is larger, a space loss thereof is also larger. Accordingly, RSSI between the wireless base station 2 and the reference terminal apparatus 4 becomes smaller than “30”.

The transmit power control unit 23 decides that the radio propagation quality does not satisfy a threshold because RSSI between the wireless base station 2 and the reference terminal apparatus 4 is smaller than “30”. In this case, the transmit power control unit 23 increases a transmit power so that RSSI is equal to “30” (S23). Briefly, a wireless connectable area 1 is enlarged to a location of the reference terminal apparatus 4, and a wireless connectable area 1′ is newly formed.

When the reference terminal apparatus 4 is moved along a distant direction from the wireless base station 2, RSSI of the reference terminal apparatus 4 is temporarily smaller than “30”. In this case, the wireless base station temporarily misses the reference terminal apparatus 4 because a radio from the reference terminal apparatus 4 cannot be decoded. As a result, a transmit power cannot be controlled because a wireless connectable area cannot be followed with the reference terminal apparatus 4. In order to avoid this situation, a threshold of RSSI should be not a value that the radio cannot be decoded at all if RSSI is smaller than the value, but a value that the radio can be decoded at the minimum even if RSSI is smaller than the value.

As shown in FIG. 3B, by enlarging a wireless connectable area, a terminal apparatus 3B can be located inside the wireless connectable area 1′ of the base station 2. As a result, the terminal apparatus 3B can stably communicate with the base station 2. When the wireless connectable area 1 of the base station 2 is enlarged as the wireless connectable area 1′, RSSI of the terminal apparatus 3B is changed from “20” to “40”, and RSSI of the terminal apparatus 3A is changed from “40” to “60”.

When the terminal apparatus 3B is located into the wireless connectable area 1′, a wireless connection to the wireless base station 2 is established. In this case, the reference terminal decision unit 21 decides that an identifier of the terminal apparatus 3B does not coincide with a reference terminal identifier stored in the reference terminal identifier storage unit 20. Accordingly, a transmit power of the base station 2 is not newly controlled based on the terminal apparatus 3B.

As mentioned-above, in the wireless LAN system of the first embodiment, by moving the reference terminal apparatus 4, a user of a terminal apparatus can easily adjust the wireless connectable area of the base station 2. Briefly, the reference terminal apparatus 4 as a reference to control a transmit power of the base station can be moved. When the reference terminal apparatus 4 is moved, the transmit power control unit 23 controls the transmit power so that RSSI between the base station 2 and the reference terminal apparatus 4 is equal to a predetermined value “30”. Accordingly, by following with movement of the reference terminal apparatus 4, the wireless connectable area of the base station 2 can be adjusted.

Furthermore, in the wireless LAN system of the first embodiment, for example, a user of the system can move a location of the reference terminal apparatus 4 so that a work space exists between a physical location of the reference terminal apparatus 4 (visually confirmable) and a physical location of the wireless base station 2.

In the first embodiment, one wireless base station 2, two terminal apparatuses 3A and 3B, and one reference terminal apparatus 4, are used. However, at least two wireless base stations, one or at least three terminal apparatuses, and at least two reference terminal apparatuses 4, may be used.

### The Second Embodiment

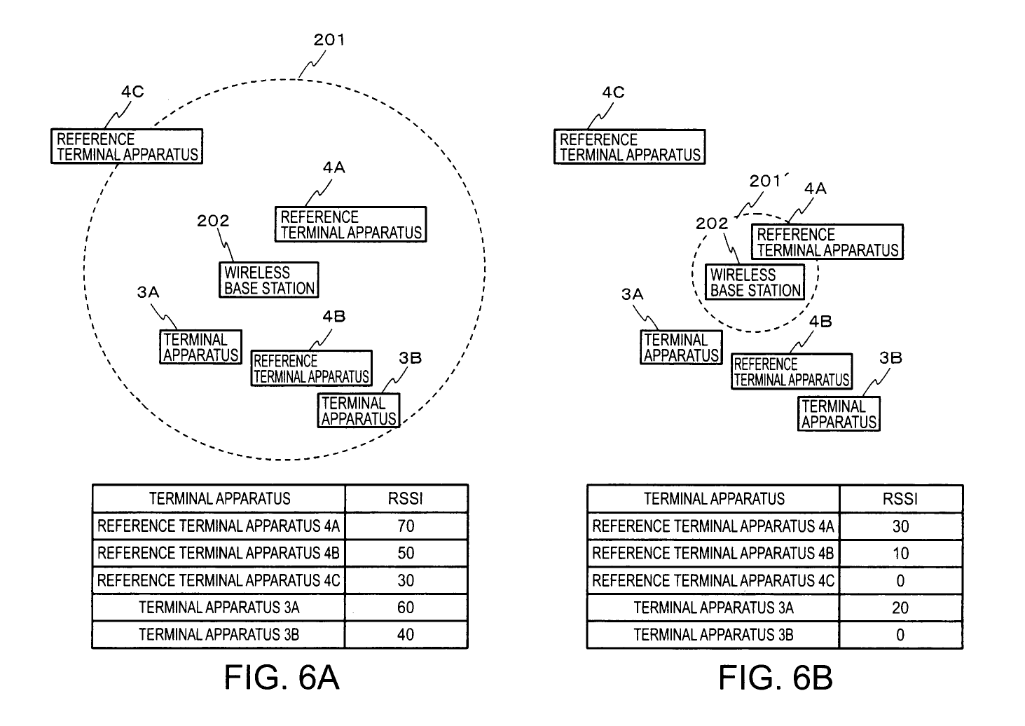

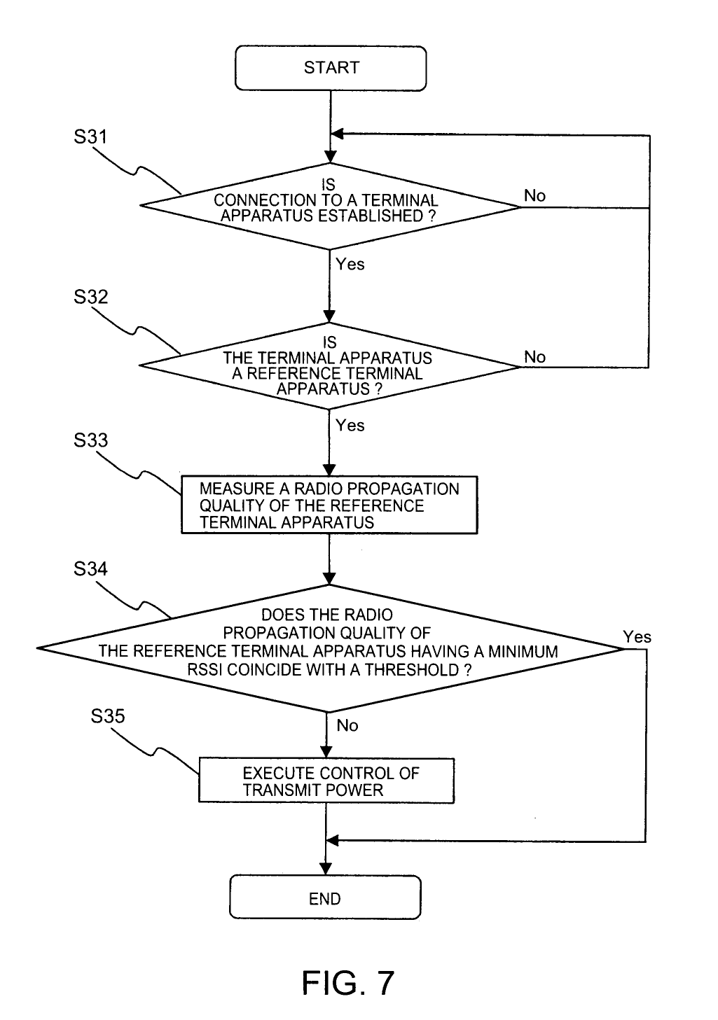

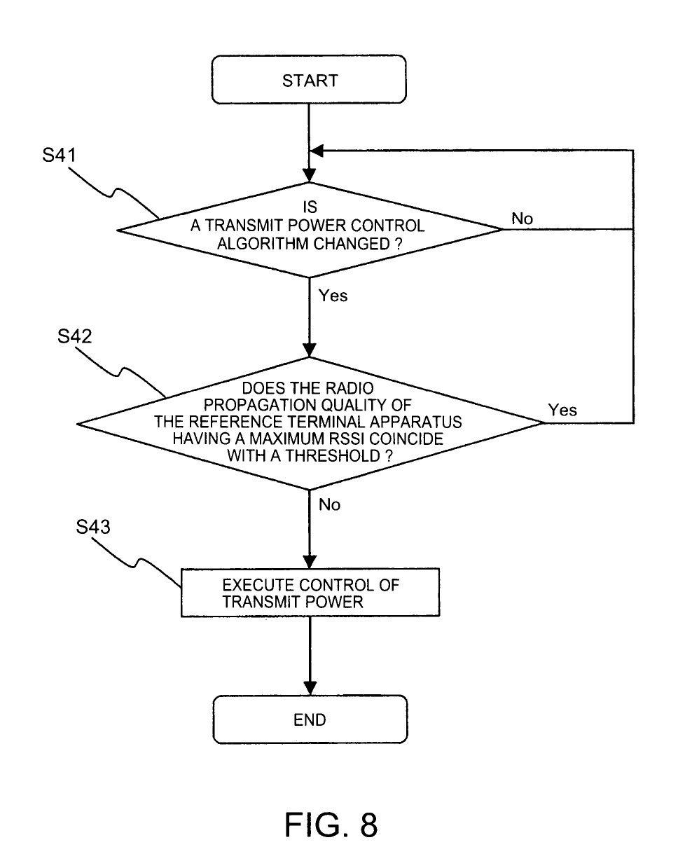

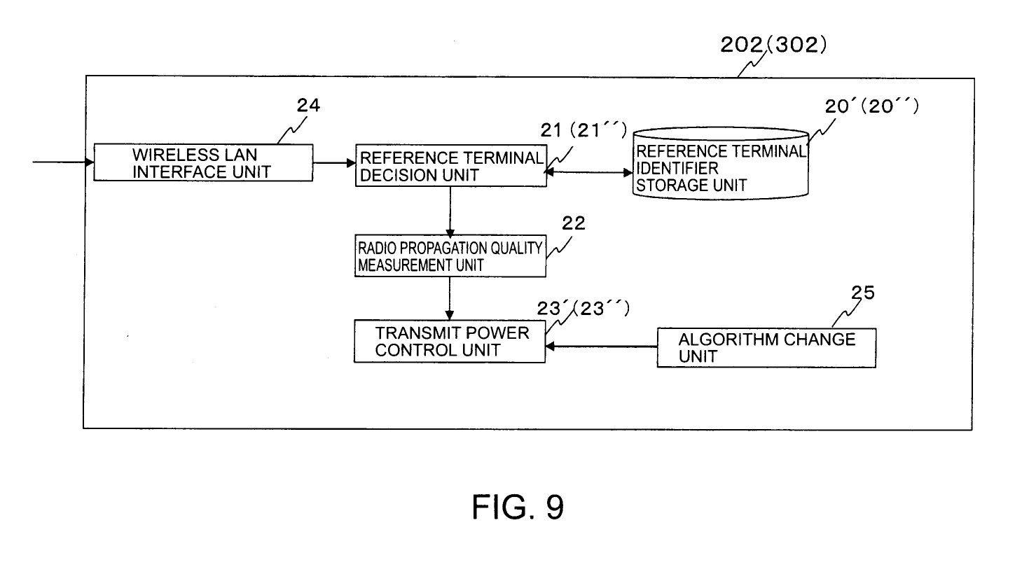

FIGS. 6A and 6B are block diagrams of the wireless LAN system according to the second embodiment. FIG. 6A is a block diagram showing an initial quality of the wireless LAN system before the wireless connectable area of the base station 202 is changed. FIG. 6B is a block diagram showing a quality of the wireless LAN system after the wireless connectable area of the base station 202 is changed. FIG. 7 is a flow chart of processing of the wireless base station 202 to initially set the wireless connectable area in the wireless LAN system. FIG. 8 is a flow chart of processing of the wireless base station 202 to change the wireless connectable area in the wireless LAN system. FIG. 9 is a block diagram of the wireless base station 202 of the second embodiment.

In the wireless LAN system of the second embodiment, one base station 202 having a wireless connectable area 201, two terminal apparatuses 3A and 3B, and three reference terminal apparatuses 4A, 4B and 4C, are included. The two terminal apparatuses 3A and 3B, and the three reference terminal apparatuses 4A, 4B and 4C, have the same function as the terminal apparatus and the reference terminal apparatus of the first embodiment respectively. Accordingly, their explanations are omitted.

In the wireless LAN system of the second embodiment, three reference terminal apparatuses 4A, 4B and 4C are different from one reference terminal apparatus of the first embodiment. Furthermore, as shown in FIG. 9, the wireless base station 202 of the second embodiment has an algorithm change unit 25.

In FIG. 9, the algorithm change unit 25 controls a transmit power control unit 23′ to change a transmit power control algorithm. In this case, the algorithm change unit 25 operates by an indication from a user of the terminal apparatus or a manager of the base station 202. For example, when the manager of the base station 202 indicates via a GUI set in the base station 202, the algorithm change unit 25 is operated. Furthermore, when the user of the terminal apparatus pushes a button (representing an algorithm) set in the reference terminal apparatus and the reference terminal apparatus informs the algorithm to the base station 202, the algorithm change unit 25 of the base station 202 is operated. The algorithm change unit 25 may be included in the transmit power control unit 23′. In the wireless base station 202 of the second embodiment, a reference terminal identifier storage unit 20′ stores three reference terminal identifiers of reference terminal apparatuses 4A, 4B and 4C.

Furthermore, in the wireless base station 202 of the second embodiment, in response to an indication from the algorithm change unit 25, the transmit power control unit 23′ selectively changes a plurality of algorithms. Based on a radio propagation quality measured by the radio propagation quality measurement unit 22, the transmit power control unit 23′ controls the wireless connectable area by changing following two algorithms (method for controlling the transmit power of the base station 202).

(1) The transmit power is controlled so that RSSI of the reference terminal apparatus having the maximum RSSI is equal to “30”.

(2) The transmit power is controlled so that RSSI of the reference terminal apparatus having the minimum RSSI is equal to “30”.

Next, as to the second embodiment, a method for controlling the wireless connectable area of the base station 202 is explained. First, a method for controlling the base station 202 to set the wireless connectable area based on the reference terminal apparatus 4A (as an initial quality) is explained. In the wireless connectable area of the base station before the initial quality, terminal apparatuses 3A and 3B, and reference terminal apparatuses 4A, 4B and 4C, exist.

The base station 202 wirelessly connects with the terminal apparatuses 3A and 3B, and the reference terminal apparatuses 4A, 4B and 4C in the wireless connectable area respectively, and a wireless connection to each unit is established (S31). In case of establishing the wireless connection, a wireless LAN interface unit 24 of the base station 202 receives identifiers from the terminal apparatuses 3A and 3B, and reference terminal identifiers from the reference terminal apparatuses 4A, 4B and 4C respectively.

Next, the reference terminal decision unit 21 decides whether these identifiers (received from each terminal) coincide with reference terminal identifiers stored in the reference terminal identifier storage unit 20′ (S32). In this case, the reference terminal decision unit 21 decides that identifiers received from the reference terminal apparatuses 4A, 4B and 4C coincide with reference terminal identifiers stored in the reference terminal identifier storage unit 20′. On the other hand, the reference terminal decision unit 21 decides that identifiers received from the reference terminal apparatuses 3A and 3B do not coincide with reference terminal identifiers stored in the reference terminal identifier storage unit 20′. As a result, the reference terminal decision unit 21 decides that the reference terminal apparatuses 4A, 4B and 4C are used as a reference to control the transmit power.

Next, the radio propagation quality measurement unit 22 measures RSSI between the base station 202 and each reference terminal apparatus 4A, 4B and 4C (S33). In above-mentioned algorithms (1)-(3) preset based on a measurement result of the radio propagation quality measurement unit 22, the transmit power control unit 23′ controls the transmit power by the algorithm (2), i.e., so that RSSI of the reference terminal apparatus having the minimum RSSI is equal to “30”.

As shown in FIG. 6A, the reference terminal apparatus 4C is most distant from the base station 202 among three reference terminal apparatuses 4A, 4B and 4C. Accordingly, the base station 202 controls a transmit power so that RSSI of the reference terminal apparatus 4C is equal to “30”. If RSSI of the reference terminal apparatus 4C is smaller or larger than “30”, the transmit power control unit 23′ decides that RSSI does not satisfy a threshold (S34). If RSSI of the reference terminal apparatus 4C is smaller than “30”, the transmit power control unit 23′ increases the transmit power. If RSSI of the reference terminal apparatus 4C is larger than “30”, the transmit power control unit 23′ decreases the transmit power (S35).

Accordingly, as shown in FIG. 6A, RSSI between the wireless base station 202 and the reference terminal apparatus 4C becomes “30”, and a wireless connectable area 201 of the base station 202 is formed so that the wireless connectable area is followed by a physical location of the reference terminal apparatus 4C.

At an initial quality shown in FIG. 6A, RSSI of the reference terminal apparatuses 4A, 4B and 4C, and the terminal apparatuses 3A and 3B, is “70”, “50”, “30”, “60” and “40” respectively. Accordingly, at the initial quality, each radio propagation quality of the terminal apparatus 3A and 3B is excellent to stably communicate.

Next, a method for changing the wireless connectable area of the base station 202 is explained. Concretely, the transmit power control unit 23′ changes above-mentioned algorithm from algorithm (2) (the transmit power is controlled so that RSSI of the reference terminal apparatus having the minimum RSSI is equal to “30”) to algorithm (1) (the transmit power is controlled so that RSSI of the reference terminal apparatus having the maximum RSSI is equal to “30”).

First, by activating the algorithm change unit 25, a transmit power control algorithm of the transmit power control unit 23′ is changed from (2) to (1). The transmit power control unit 23′ detects that the transmit power control algorithm is changed from (2) to (1) (S41).

Next, Based on a measurement result of the radio propagation quality measurement unit 22, the transmit power control unit 23′ controls a transmit power so that RSSI of the reference terminal apparatus 4A having the maximum RSSI is equal to “30”. When RSSI of the reference terminal apparatus 4A is not equal to “30”, the transmit power control unit 23′ decides that RSSI does not satisfy a threshold. Briefly, when RSSI of the reference terminal apparatus 4A is smaller or larger than “30”, the transmit power control unit 23′ decides that RSSI does not satisfy a threshold (S42). In this case, when RSSI of the reference terminal apparatus 4A is smaller than “30”, the transmit power control unit 23′ increases the transmit power. On the other hand, when RSSI of the reference terminal apparatus 4A is larger than “30”, the transmit power control unit 23′ decreases the transmit power (S43).

As shown in FIG. 6A, RSSI of the reference terminal apparatus 4A is “70”. Accordingly, the transmit power control unit 23′ decreases the transmit power. As shown in FIG. 6B, by changing the transmit power control algorithm, the wireless connectable area can be enlarged or reduced.

As mentioned-above, by changing the transmit power control algorithm, the wireless base station 202 forms a wireless connectable area 201′ based on the reference terminal apparatus 4A. After changing the transmit power control algorithm, RSSI of the reference terminal apparatuses 4A, 4B and 4C, and the terminal apparatuses 3A and 3B, are “30”, “10”, “0”, “20” and “0” respectively. As a result, each radio propagation quality of the terminal apparatuses 3A and 3B grows worth, and the base station 202 cannot communicate with the terminal apparatuses 3A and 3B.

Briefly, in the wireless LAN system of the second embodiment, by changing the transmit power control algorithm of the base station, the wireless connectable area of the base station is easily changed. As a use of the wireless LAN system, for example, when a radio trouble occurs around the base station, a manager of the base station must research a reason of the radio trouble. In this case, in order to separate a problem for each terminal apparatus, a radio from the base station can be temporarily cut off for each terminal apparatus.

In the wireless LAN system of the second embodiment, in the same way as the first embodiment, the wireless connectable area is set based on a location of the reference terminal apparatus. Accordingly, a user can easily cover a specified space by the wireless connectable area. In addition to this, by watching the reference terminal apparatus, the user can understand a location where the user's terminal can stably communicate with the base station in the wireless connectable area.

Furthermore, in the wireless LAN system of the second embodiment, in the same way as the first embodiment, by moving the reference terminal apparatus, the user can easily adjust (enlarges or reduces) the wireless connectable area of the base station. In addition to this, the wireless connectable area can be prescribed as a predetermined area.

### The Third Embodiment

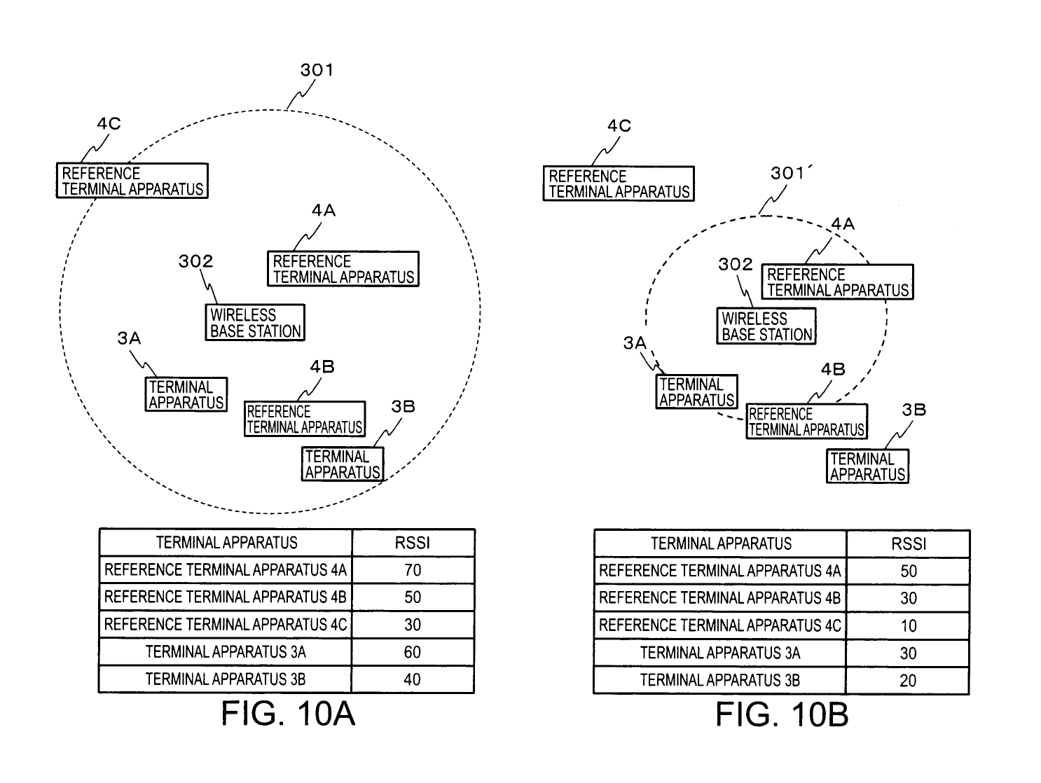

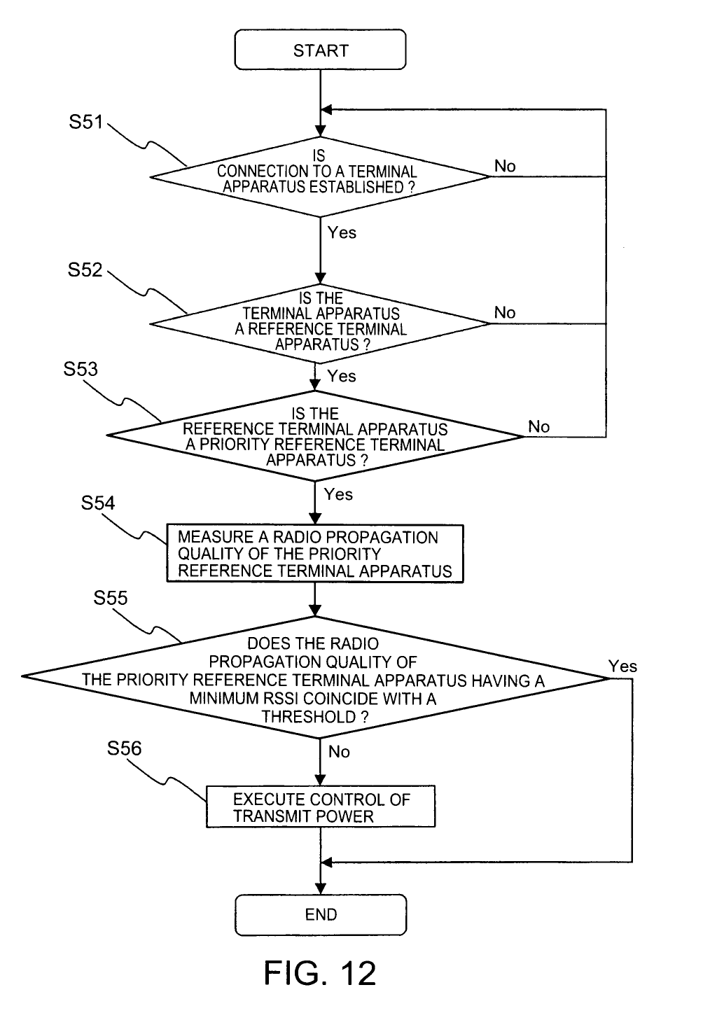

FIGS. 10A and 10B are block diagrams of the wireless LAN system according to the third embodiment. FIG. 10A is a block diagram showing an initial quality of the wireless LAN system before the wireless connectable area of the base station 302 is changed. FIG. 10B is a block diagram showing a quality of the wireless LAN system after the wireless connectable area of the base station 302 is changed. FIG. 12 is a flow chart of processing of the wireless base station 302 to change the wireless connectable area in the wireless LAN system. FIG. 9 is a block diagram of the wireless base station 302 of the third embodiment.

In the wireless LAN system of the third embodiment, a reference terminal identifier storage unit 20″ stores a reference terminal identifier of a priority reference terminal apparatus with a priority degree information. The priority reference terminal apparatus is preferentially used as a reference to control a transmit power by a transmit power control unit 23″. The priority degree information distinguishes the priority reference terminal apparatus from the (regular) reference terminal apparatus.

A reference terminal decision unit 21″ decides the priority reference terminal apparatus by referring to the priority degree information. The transmit power control unit 23″ controls the transmit power for the priority reference terminal apparatus only. Above-mentioned feature is different from the wireless LAN system of the second embodiment. In this case, the priority degree information may be dynamically changed.

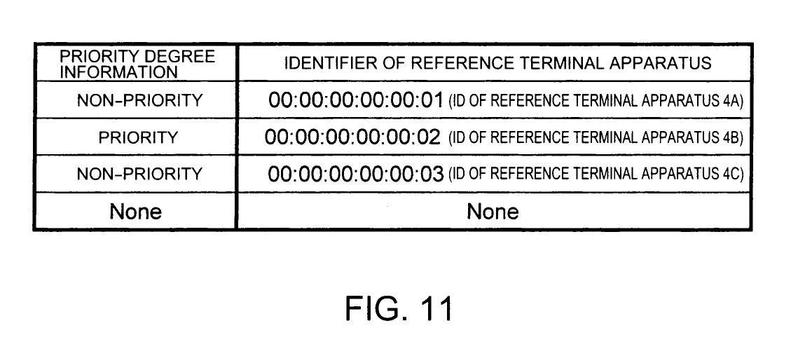

FIG. 11 shows a database storing a reference terminal identifier (managed by the reference terminal identifier storage unit 20″) and the priority degree information. A method for controlling the wireless connectable area of the base station 302 is explained. As shown in FIG. 10A, at an initial quality of the wireless connectable area 301 of the base station 302, RSSI of the reference terminal apparatuses 4A, 4B and 4C, and the terminal apparatuses 3A and 3B, are “70”, “50”, “30”, “60” and “40” respectively.

First, the wireless base station 302 establishes a wireless connection to the reference terminal apparatuses 4A, 4B and 4C, and the terminal apparatuses 3A and 3B in the wireless connectable area 301 (S51).

Next, the reference terminal decision unit 21″ decides whether each identifier received from the outside (the reference terminal apparatuses 4A, 4B and 4C, and the terminal apparatuses 3A and 3B) coincide with reference terminal identifiers stored in the reference terminal identifier storage unit 20″ respectively (S52). In this case, identifiers received from the reference terminal apparatuses 4A, 4B and 4C coincide with reference terminal identifiers stored in the reference terminal identifier storage unit 20′. Accordingly, the reference terminal decision unit 21″ decides that the reference terminal apparatuses 4A, 4B and 4C are reference terminals.

Next, at the same timing as S52 or after S52, by referring to the priority degree information stored in the reference terminal identifier storage unit 20′, the reference terminal decision unit 21″ decides whether reference terminal decision unit 21″ decides whether the reference terminal apparatuses 4A, 4B and 4C are a priority reference terminal apparatus (S53). In the third embodiment, as shown in FIG. 11, the reference terminal apparatus 4B is decided as the priority reference terminal apparatus.

Next, the radio propagation quality measurement unit 22 measures RSSI (radio propagation quality) between the wireless base station 302 and the reference terminal apparatus 4B (S54). Following steps are same as the second embodiment.

As mentioned-above, in the wireless LAN system of the third embodiment, the reference terminal identifier storage unit 20″ stores the priority degree information. Accordingly, the wireless connectable area 301′ is formed based on a location of the priority reference terminal apparatus 4B. In this case, as shown in FIG. 10B, RSSI of the reference terminal apparatuses 4A, 4B and 4C, and the terminal apparatuses 3A and 3B, are “50”, “30”, “10”, “30” and “20” respectively.

Briefly, in addition to identifiers of the reference terminal apparatuses, the reference terminal identifier storage unit 20″ stores the priority degree information of the priority reference terminal apparatus as a priority object to control a transmit power. Accordingly, by desirably selecting the priority reference terminal apparatus from the reference terminal apparatuses, a user can easily adjust the wireless connectable area in the LAN system. Furthermore, the LAN system of the third embodiment has the same effect as the second embodiment.

In the third embodiment, one wireless base station 2, two terminal apparatuses 3A and 3B, and three reference terminal apparatuses 4A, 4B and 4C, are used. However, at least two wireless base stations, one or at least three terminal apparatuses, and two or at least four reference terminal apparatuses 4, may be used. For example, if a plurality of base stations exists, by overlapping the wireless connectable area of each base station, the radio interference often occurs. In such environment, by moving the reference terminal apparatus, the user can easily adjust the wireless connectable area to remove the overlap.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. A wireless base station comprising:
a storage unit configured to store an identifier of a reference terminal apparatus to control a wireless connectable area of the wireless base station;
a decision unit configured to decide whether an identifier received from the outside coincides with the identifier stored in the storage unit; and
a control unit configured to control a transmit power so that a radio propagation quality between the wireless base station and the reference terminal apparatus represents the wireless connectable area, when the identifier received from the outside coincides with the identifier stored in the storage unit.

2. The wireless base station according to claim 1, wherein
the control unit communicates with all terminal apparatuses in the wireless connectable area by the transmit power controlled.

3. The wireless base station according to claim 1, wherein
the reference terminal apparatus has an appearance visually confirmable for a user, compared with other terminal apparatuses.

4. The wireless base station according to claim 1, wherein
the reference terminal apparatus is movable by a user, and
the control unit controls the transmit power so that the radio propagation quality represents the wireless connectable area by following the reference terminal apparatus moved with the user.

5. The wireless base station according to claim 1, wherein
the control unit selects a specified reference terminal apparatus from a plurality of reference terminal apparatuses, and controls the transmit power so that the radio propagation quality between the wireless base station and the specified reference terminal apparatus represents the wireless connectable area,
a reference terminal apparatus having the radio propagation quality higher than the specified reference terminal apparatus can be wirelessly connectable with the wireless base station, and
a reference terminal apparatus having the radio propagation quality lower than the specified reference terminal apparatus cannot be wirelessly connectable with the wireless base station.

6. The wireless base station according to claim 5, wherein
the specified reference terminal apparatus has the highest radio propagation quality among the plurality of reference terminal apparatuses.

7. The wireless base station according to claim 6, wherein
the specified reference terminal apparatus has the lowest radio propagation quality among the plurality of reference terminal apparatuses.

8. The wireless base station according to claim 5, wherein
the specified reference terminal apparatus can be replaced with any of the plurality of reference terminal apparatuses.

9. The wireless base station according to claim 5, wherein
the storage unit stores the identifier of a priority reference terminal apparatus for which the control unit controls the transmit power preferentially among the plurality of reference terminal apparatuses, and
the control unit selects the specified reference terminal apparatus from a plurality of priority reference terminal apparatuses.

10. The wireless base station according to claim 9, wherein
the priority reference terminal apparatus can be replaced with any of the plurality of reference terminal apparatuses.

11. A reference terminal apparatus to control a wireless connectable area of a wireless base station, comprising:
a storage unit configured to store an identifier of the reference terminal apparatus, the identifier being stored in the wireless base station; and
an interface unit configured to wirelessly transmit the identifier to the wireless base station.

12. The reference terminal apparatus according to claim 11, wherein
the reference terminal apparatus has a shape or an appearance visually confirmable than another terminal apparatus.

13. The reference terminal apparatus according to claim 11, wherein
the reference terminal apparatus is movable by a user.

14. A wireless communication system comprising:
a wireless base station which stores an identifier of a reference terminal apparatus to control a wireless connectable area of the wireless base station; and
the reference terminal apparatus which stores the identifier;
wherein the reference terminal apparatus wirelessly transmits the identifier to the wireless base station, and
wherein the wireless base station control a transmit power so that a radio propagation quality between the wireless base station and the reference terminal apparatus represents the wireless connectable area, when the identifier received from the reference terminal apparatus coincides with the identifier stored in the wireless base station.
